(19) United States
(12) Patent Application Publication
(10) Pub. No.: US 2026/0181169 A1
(43) Pub. Date: Jun. 25, 2026

(54) AREA EFFICIENT ON-THE-FLY ENCODER STATISTICS COMPUTATION UNIT FOR VIDEO ENCODING

(71) Applicant: QUALCOMM Incorporated, San Diego, CA (US)

(72) Inventors: Garimella Rama Aditya, Hyderabad (IN); Balasubrahmanya Kudlu, Kasaragod (IN); Krishna Murthy, Bengaluru (IN); Sandeep Nellikatte Srivatsa, Bangalore (IN); Ashish Mishra, Bhubaneswar (IN)

(21) Appl. No.: 18/989,586

(22) Filed: Dec. 20, 2024

(51) Int. Cl. H04N 19/423; H04N 19/149; H04N 19/182

(52) U.S. Cl. CPC H04N 19/423; H04N 19/149; H04N 19/182

(57) ABSTRACT

A hardware-based video encoder includes a memory configured to store statistics of video data; statistics computing circuitry comprising a plurality of counting blocks, wherein each counting block of the plurality of counting blocks comprises comparator circuitry configured to compare a value of each input pixel of a set of input pixel values to a set value; and accumulator circuitry configured to update the statistics based on a number of the input pixels of the set of input pixel values that are determined by the comparator circuitry to be equal to the set value.

### TECHNICAL FIELD

This disclosure relates to video encoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, extended reality devices, cellular or satellite radio telephones, so-called “smart phones,” video teleconferencing devices, video streaming devices, and the like. Digital video capabilities are also implemented in other types of systems such as autonomous navigation systems for automobiles and other types of vehicles. The video devices may transmit, receive, encode, decode, and/or store digital video information more efficiently by implementing such video coding techniques.

### SUMMARY

The techniques of this disclosure relate to hardware for video encoding and, more specifically, to video encoding hardware for encoding high bit rate original (i.e., unencoded) video content. better video quality but also larger file sizes and more bandwidth required for transmission. A video encoder may be configured to perform rate-distortion optimization to balance the trade-off between decoded video quality and the bit rate of encoded video data. One of the parameters that most significantly affects rate-distortion tradeoff is the amount of quantization used to signal pixel values, with more quantization generally providing more compression but lower decoded video quality, and less quantization providing less compression but generally better decoded video quality.

Most video encoders require computation of statistics on-the-fly, for example, for maintaining a target bit rate (i.e., rate control) and other purposes. In a RAM based approach, the statistics are typically computed by comparing each value of an encoded coefficient and updating each of the corresponding locations in a look-up-table in RAM. Using such an approach requires more hardware area, e.g., more circuitry, for high bit rate encoders, which also corresponds to higher costs, more heat generation, more power consumption, and other undesirable consequences.

This disclosure describes an alternative to the RAM-based approach introduced above. This disclosure describes an area efficient adder and comparator-based approach for achieving a desired performance. The techniques of this disclosure allow for performance scaling without as much area scaling compared to the RAM based approach described above.

According to an example of this disclosure, a hardware-based video encoder includes a memory configured to store statistics of video data; statistics computing circuitry comprising a plurality of counting blocks, wherein each counting block of the plurality of counting blocks comprises comparator circuitry configured to compare a value of each input pixel of a set of input pixel values to a set value; accumulator circuitry configured to update the statistics based on a number of the input pixels of the set of input pixel values that are determined by the comparator circuitry to be equal to the set value; control a video encoding process based on the updated statistics.

According to an example of this disclosure, a method of encoding video data includes storing, in a memory, statistics of video data; comparing, by comparator circuitry, a value of each input pixel of a set of input pixel values to a set value; updating, by accumulator circuitry, the statistics based on a number of the input pixels of the set of input pixel values that are determined by the comparator circuitry to be equal to the set value; controlling a video encoding process based on the updated statistics.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example statistics compute module which may be included in a video encoder.

FIG. 3 is a block diagram illustrating an example video encoder that may perform the techniques of this disclosure.

FIG. 4 is a flowchart illustrating an example process for storing statistics for encoding video data with the techniques of this disclosure.

FIG. 5 is a conceptual diagram illustrating an example vehicle-based scenario in which one or more techniques of this disclosure may be used.

FIG. 6 is a conceptual diagram illustrating an example extended reality system in which one or more techniques of this disclosure may be used.

### DETAILED DESCRIPTION

Prediction-based video encoding schemes involve predicting a block of video data from either an already coded block of video data in the same picture (e.g., intra prediction) or an already coded block of video data in a different picture (e.g., inter prediction). In some instances, the video encoder also calculates residual data by comparing the prediction block to the original block. Thus, the residual data represents a difference between the prediction block and the original block. To reduce the number of bits needed to signal the residual data, the video encoder transforms and quantizes the residual data and signals the transformed and quantized residual data in the encoded bitstream. The compression achieved by the transform and quantization processes may be lossy, meaning that transform and quantization processes may introduce distortion into the decoded video data.

A video decoder decodes and adds the residual data to the prediction block to produce a reconstructed video block that matches the original video block more closely than the prediction block alone. Due to the loss introduced by the transforming and quantizing of the residual data, the first reconstructed block may have distortion or artifacts. One common type of artifact or distortion is referred to as blockiness, where the boundaries of the blocks used to code the video data are visible. To further improve the quality of decoded video, a video decoder can perform one or more filtering operations on the reconstructed video blocks.

Other video coding schemes apply transformation and quantization directly to pixel values rather than residual values. The techniques of this disclosure are not limited to any specific type of video encoding and may be applied to residual data, pixel data, or other such data.

The techniques of this disclosure relate to hardware for video encoding and, more specifically, to video encoding hardware for encoding high bit rate original (i.e., unencoded) video content, such as video that requires more than 3 gigabits per second (GbPS). For example, unencoded 4K video with 8-bit color depth and no chroma subsampling at 30 frames per second (fps) can have a bit rate of approximately 6 GbPS, while 4K video with 10-bit color depth and no chroma subsampling at 30 fps can have a bit rate of approximately 7.5 GbPS. Higher resolutions (e.g., 8K), higher bit color depths (e.g., 12-bit), and higher frame rates (e.g., 60 or 120 fps) can all produce even higher bit rates. Higher bit rates generally result in better video quality but also larger file sizes and more bandwidth required for transmission.

A video encoder may be configured to perform rate-distortion optimization to balance the trade-off between decoded video quality and the bit rate of encoded video data. One of the parameters that most significantly affects rate-distortion tradeoff is the amount of quantization used to signal pixel values, with more quantization generally providing more compression but lower decoded video quality, and less quantization providing less compression but generally better decoded video quality.

Most video encoders require computation of statistics on-the-fly, for example, for maintaining a target bit rate (i.e., rate control) and other purposes. Some video encoders require updating multiple entries in a look-up table (LUT) in hardware on every clock cycle. For example, a video encoder may maintain a histogram that counts the occurrence of all values and maintain counts of the number of non-zero transform coefficients in the frame after quantization. Another example is deriving the relationship between the quantization parameter (QP) and the percentage of zero coefficients (rho) in a transformed block, which may be referred as the rho-qp parameter. The statistics may also be used for other purposes as well.

For achieving a performance of “P” pixels per clock cycle (ppc), which represents encoder performance, a video encoder needs to process all the coefficient values in a single clock cycle. In a RAM based approach, the statistics are typically computed by comparing each value of an encoded coefficient and updating each of the corresponding locations in a look-up-table in RAM. For higher performance requirements, the number of RAM locations required scales accordingly, which makes this implementation less area efficient when higher performance is required. In this implementation, achieving ‘P’ ppc requires ‘P’ RAMs. The area required can be modelled with equation (1).

$$( P \times L \times width \times ( 1 - bit SRAM area ) ) + ( area of adders ) + ( LUT area ) \qquad ( 1 )$$

In the equation above, L corresponds to the number of possible values of pixels, which is a function of bit depth (bd). For example, 8-bit video may have 256 values, while 10-bit video may have 1024 values. Width corresponds to the color bit width, and P is as described above.

Using the above-described RAM approach requires more hardware area, e.g., more circuitry, for high bit rate encoders, which also corresponds to higher costs, more heat generation, more power consumption, and other undesirable consequences.

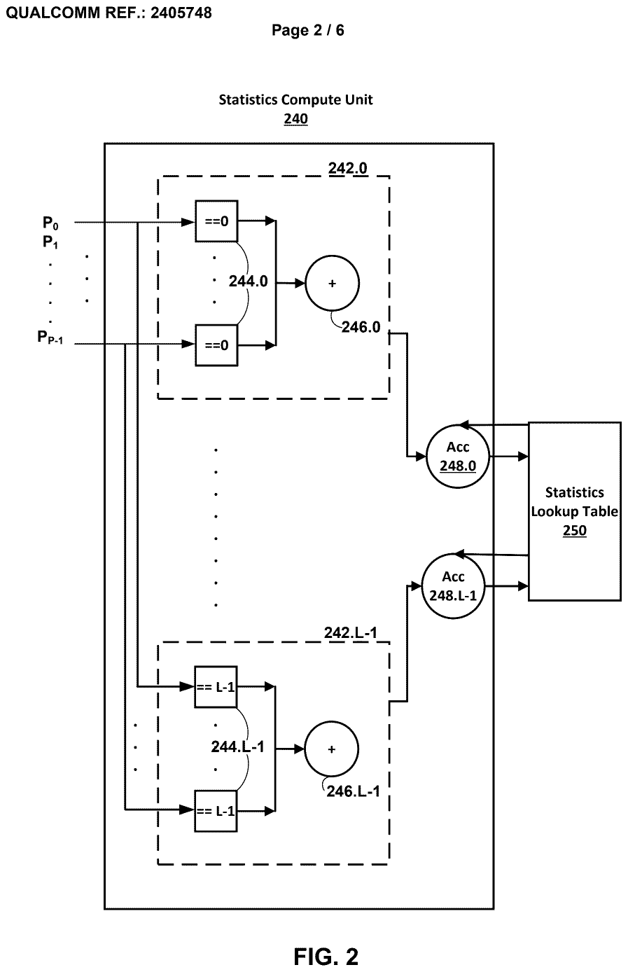

This disclosure describes an alternative to the RAM-based approach introduced above. This disclosure describes an area efficient adder and comparator-based approach for achieving a desired P ppc. The adder and comparator-based approach, as described below with respect to FIG. 2, utilizes a flop-based implementation that uses ‘P*L’ comparators, ‘P’ adders, and ‘P’ accumulators. The area required can be modelled with equation (2).

$$( L \times width \times 1 - bit flop area ) + ( area of comparators + adders + accumulators ) \qquad ( 2 )$$

In equation (2), the storage area required in the proposed implementation is independent of P, whereas in equation (1), the number of SRAMS is a function of P. Thus, the techniques of this disclosure allow for performance scaling without as much area scaling compared to the RAM based approach described above.

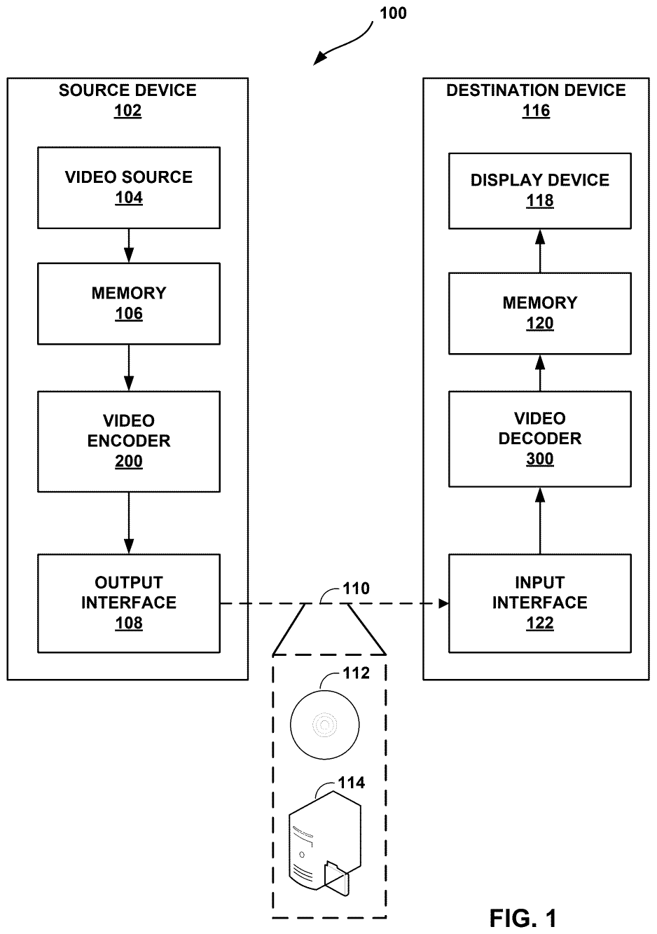

FIG. 1 is a block diagram illustrating an example video encoding and decoding system 100 that may perform the techniques of this disclosure. The techniques of this disclosure are generally directed to encoding video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, extended reality devices (e.g., augmented reality or virtual reality), autonomous navigation systems, or the like. In some cases, source device 102 and destination device 116 may be equipped for wireless communication, and thus may be referred to as wireless communication devices.

In some implementations of the techniques of this disclosure, source device 102 may be used in conjunction with other types of destination devices that do not necessarily display the decoded video data. For example, source device 102 may transmit the encoded video data to an autonomous navigation system of a vehicle, such as an autonomous driving system of an automobile or an autonomous flying system of an unmanned aerial vehicle.

In the example of FIG. 1, source device 102 includes video source 104, memory 106, video encoder 200, and output interface 108. Destination device 116 includes input interface 122, video decoder 300, memory 120, and display device 118. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding device may perform the techniques described herein. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1(AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

FIG. 2 shows a diagram illustrating statistics compute unit 240, which may, for example, be included in video encoder 200 or included in other types of video encoders. Statistics compute unit 240 includes counting blocks 242.0 through 242.L-1 (collectively referred to herein as “counting blocks 242”). The number of counting blocks in statistics compute unit 240 may be equal to the range of pixel values, or a maximum range of pixel values, for video data being encoded. For example, for 8-bit video, statistics compute unit 240 may include 2⁸ (i.e., 256) counting blocks, or for 10-bit video, statistics compute unit 240 may include 2¹⁰ (i.e., 1024) counting blocks. Each of counting blocks 242 includes comparison logic 244 and summing logic 246.

Each of counting blocks 242 is configured to receive pixel values (P₀ to P_{P-1}) and compare the pixel value to a set value. For example, comparison logic 244.0 compares pixels P₀ through P_{P-1} to the value 0 and generates true (1) or false (0) outputs, and summing logic 246.0 sums the values of the true and false outputs. Comparison logic 244.1 compares pixels P₀ through P_{P-1} to the value 1 and generates true (1) or false (0) outputs, and summing logic 246.1 sums the values of the true and false outputs, and so forth, through comparison logic 244.L-1 which compares pixels P₀ through P_{P-1} to the value L-1 and generates true (1) or false (0) outputs, and summing logic 246.L-1 sums the values of the true and false outputs.

Comparison logic 244 may be implemented using a variety of hardware implementations. For example, comparison logic 244 may be implemented as an arrangement of logic gates (e.g., XNOR, AND, OR gates) using CMOS technology or other transistor-based technologies. In some examples, comparison logic may be implemented as an FPGAs using look-up tables, multiplexers and flip flops. It is also contemplated that comparison logic 244 may be implemented using quantum circuitry, memristors, optical adders, or other such components.

Each counting block outputs the sum of summing logic 246 to accumulator circuitry 248, which updates a location in statistics look-up table 250. Statistics look-up table 250 stores the number of occurrences each specific pixel value, e.g., 0 through 2^{bd}-1 with bd corresponding to the bit depth of the video being encoded, for a portion of video data. The L locations correspond to the range of possible pixel values, i.e., 0 to 2^{bd}-1. The portion of video data may, for example, be a frame, a group of frames, or a subset of frame, e.g., a slice. Accumulator 248.0 reads a value corresponding to the number of occurrences of the pixel value 0, adds the output of summing logic 246.0 to the value, and stores the updated value back in statistics look-up table 250. Accumulator 248.1 reads a value corresponding to the number of occurrences of the pixel value 1, adds the output of summing logic 246.1 to the value, and stores the updated value back in statistics look-up table 250, and so on through accumulator circuitry 248.L-1, which reads a value corresponding to the number of occurrences of the pixel value L-1, adds the output of summing logic 246.L-1 to the value, and stores the updated value back in statistics look-up table 250.

Summing logic 246 may be implemented using a variety of hardware implementations. For example, comparison logic 244 may be implemented as an arrangement of logic gates (e.g., XNOR, AND, OR gates) using CMOS technology or other transistor-based technologies. In some examples, comparison logic may be implemented as programmable logic devices or FPGAs using look-up tables, multiplexers, and flip flops. It is also contemplated that summing logic 246 may be implemented using quantum circuitry, memristors, optical adders, or other such components.

Accumulator circuitry 248 may be implemented as a combination of multi-bit accumulators, n-bit adders, n-bit registers, control circuitry, which may be implemented as an arrangement of logic gates (e.g., XNOR, AND, OR gates) using CMOS technology or other transistor-based technologies. In some examples, comparison logic may be implemented as programmable logic devices or FPGAs using look-up tables, multiplexers, and flip flops. It is also contemplated that accumulator circuitry 248 may be implemented using quantum circuitry, memristors, optical adders, or other such components.

Statistics look-up table 250 may be implemented as a flop array, e.g., an array of flip-flops. Statistics look-up table 250 may be implemented as a 2D array of flip-flops with multiple read and multiple write ports, such that a read from the flip-flop followed by a write to the flip-flop can be done in a single clock cycle. Each location 0 to L-1 of counting blocks 242 may be associated with each row of the array, such that the flop array includes N read and write ports. The flip flops may be implemented as an arrangement of logic gates (e.g., XNOR, AND, OR gates) using CMOS technology or other transistor-based technologies.

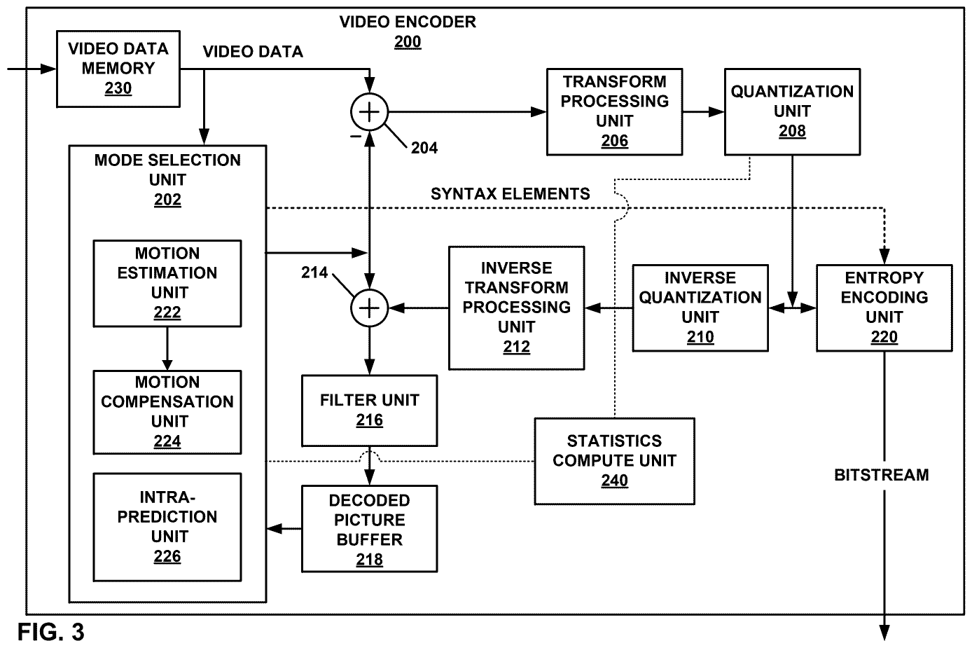

FIG. 3 is a block diagram illustrating an example video encoder 200, which includes statistics compute unit 240. FIG. 3 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). Mode selection unit 202 may be configured to perform one or both of bit-rate optimization and frame-rate control based on the statistics stored in statistics look-up table 250. For example, to achieve a desired bit rate, mode selection unit 202 may adjust a rate of intra frames and inter frames when encoding the video data.

For inter-prediction of a current block, motion estimation unit 222 may perform

a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may be configured to perform one or both of bit-rate optimization and frame-rate control based on the statistics stored in statistics look-up table 250. For example, to achieve a desired bit rate, quantization unit 208 may may adjust an amount of quantization being applied to transform coefficients.

Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

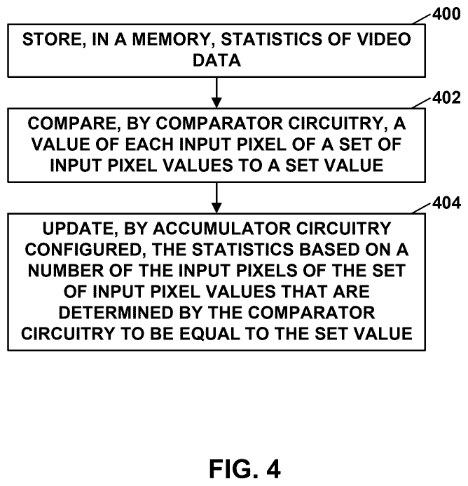

FIG. 4 is a flowchart illustrating an example process for storing statistics for encoding video data with the techniques of this disclosure. The techniques of FIG. 4 will be described with respect to a statistics compute unit, such statistics compute unit 240 of FIG. 2. In some examples, other types of devices with different hardware may perform the same techniques.

In the example of FIG. 4, the statistics compute unit stores, in a memory, statistics of video data (400). The statistics of the video data may include one or both of histogram statistics or a count of occurrences of each value between 0 and 2^{BD}-1. The memory may, for example, be a flop array.

The statistics compute unit compares, by comparator circuitry, a value of each input pixel of a set of input pixel values to a set value (402). The set of input pixel values may include one or both of residual values or full range pixel values.

The statistics compute unit updates, by accumulator circuitry, the statistics based on a number of the input pixels of the set of input pixel values that are determined by the comparator circuitry to be equal to the set value (404). Statistics compute unit 240 may also compare, by the comparator circuitry, the value of each input pixel of the set of input pixel values to the a plurality of set values ranging from 0 to 2^{BD}-1 with each set value being different. Based on the statistics, a video encoder may perform one or both of bit-rate optimization or frame-rate control based on the stored statistics when encoding the video data. The video encoder may also make other decisions regarding how to encode the video data based on the stored statistics.

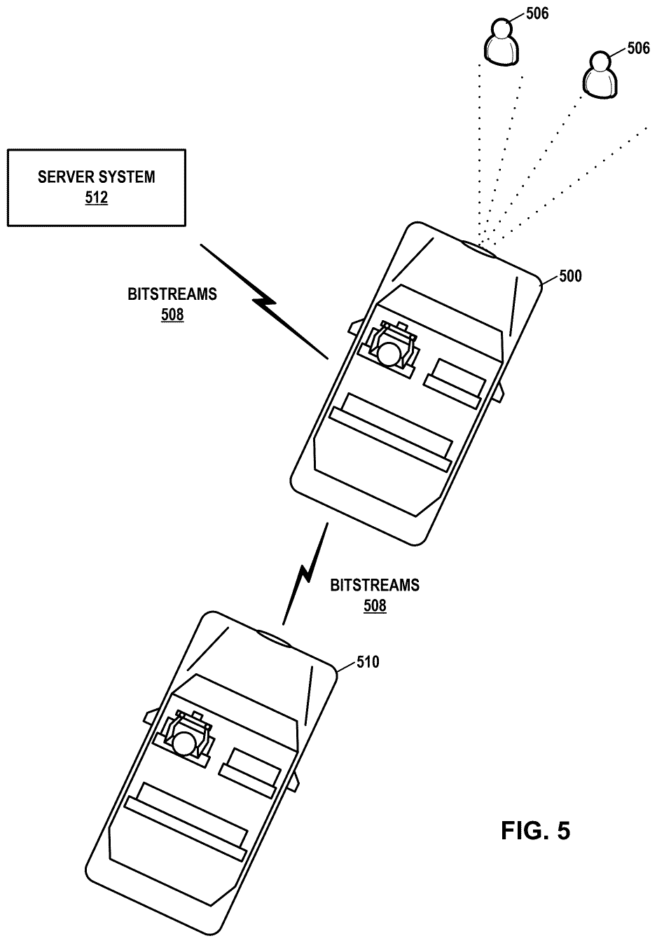

FIG. 5 is a conceptual diagram illustrating an example vehicle-based scenario in which one or more techniques of this disclosure may be used. Although not shown in the example of FIG. 5, vehicle 500 may include a video source, such as video source 104 (FIG. 1), and a video encoder, such as video encoder 200 (FIG. 1). The video encoder in vehicle 500 may include a statistics compute unit, such as statistics compute unit 240 (FIG. 2). In the example of FIG. 5, the data source of vehicle 500 acquire video data, and the video encoder of vehicle 500 may encode the video to generate bitstreams 508. An output interface of vehicle 500 (e.g., output interface 108 (FIG. 1) may transmit bitstreams 508 to one or more other devices. Bitstreams 508 may include fewer bits than the unencoded video obtained by the video encoder. Thus, vehicle 500 may be able to transmit bitstreams 508 to other devices more quickly than the unencoded point cloud data. Additionally, bitstreams 508 may require less data storage capacity on a device.

In the example of FIG. 5, vehicle 500 may transmit bitstreams 508 to another vehicle 510. Vehicle 510 may include a video decoder, such as video decoder 300 (FIG. 1). The video decoder of vehicle 510 may decode bitstreams 508 to reconstruct the video. Vehicle 510 may use the reconstructed video for various purposes. For instance, vehicle 510 may determine based on the reconstructed video that pedestrians 506 are in the roadway ahead of vehicle 500 and therefore start slowing down, e.g., even before a driver of vehicle 510 realizes that pedestrians 506 are in the roadway. Thus, in some examples, vehicle 510 may perform an autonomous navigation operation based on the reconstructed video.

Additionally or alternatively, vehicle 500 may transmit bitstreams 508 to a server system 512. Server system 512 may use bitstreams 508 for various purposes. For example, server system 512 may store bitstreams 508 for subsequent reconstruction of the video. In this example, server system 512 may use the video along with other data (e.g., vehicle telemetry data generated by vehicle 50) to train an autonomous driving system. In other example, server system 512 may store bitstreams 508 for subsequent reconstruction for forensic crash investigations.

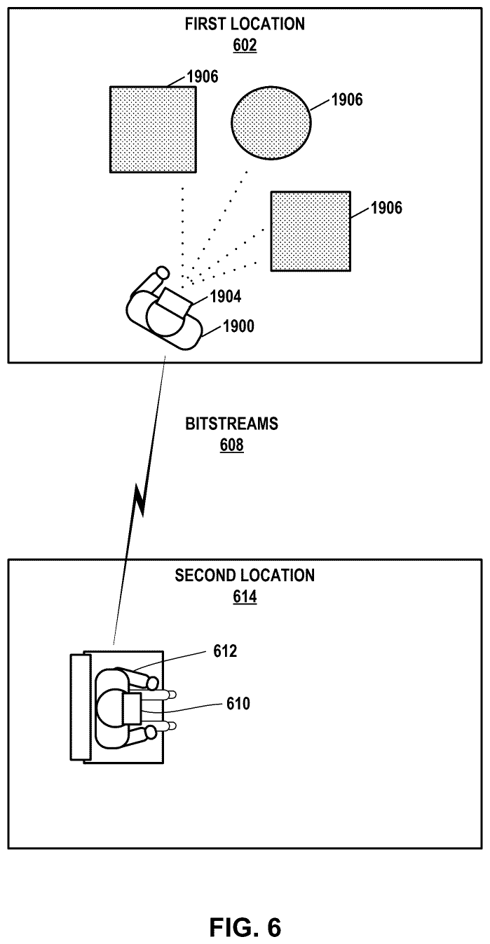

FIG. 6 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 6, a user 600 is located in a first location 602. User 600 wears an XR headset 604. As an alternative to XR headset 604, user 600 may use a mobile device (e.g., mobile phone, tablet computer, etc.). XR headset 1904 may obtain video of objects 606 at location 602. XR headset 604 may include a video encoder (e.g., video encoder 200 of FIG. 1) that is configured to encode the video to generate bitstreams 608. The video encoder in XR headset 604 may include a statistics compute unit, such as statistics compute unit 240 (FIG. 2).

XR headset 604 may transmit bitstreams 608 (e.g., via a network such as the Internet) to an XR headset 610 worn by a user 612 at a second location 614. XR headset 610 may decode bitstreams 608 to reconstruct the point cloud. XR headset 610 may use the video to generate an XR visualization (e.g., an AR, MR, VR visualization) representing objects 606 at location 602. Thus, in some examples, such as when XR headset 610 generates an VR visualization, user 612 may have a 3D immersive experience of location 602. In some examples, XR headset 610 may determine a position or other information related to a virtual object based on the reconstructed video. XR headset 610 may generate an XR visualization in which the virtual object matches an object of objects 606.

### Clause 1

A hardware-based video encoder comprising: a memory configured to store statistics of video data; statistics computing circuitry comprising a plurality of counting blocks, wherein each counting block of the plurality of counting blocks comprises comparator circuitry configured to compare a value of each input pixel of a set of input pixel values to a set value; and accumulator circuitry configured to update the statistics based on a number of the input pixels of the set of input pixel values that are determined by the comparator circuitry to be equal to the set value; control a video encoding process based on the updated statistics.

### Clause 2

The hardware-based video encoder of clause 1, wherein the comparator circuitry of each counting block of the plurality of counting blocks is configured to compare the value of each input pixel of the set of input pixels to a different set value.

### Clause 3

The hardware-based video encoder of clauses 1 or 2, wherein the memory comprises a flop array.

### Clause 4

The hardware-based video encoder of any of clauses 1-3, wherein each counting block of the plurality of counting blocks further comprises summing logic configured to sum outputs of the comparator circuitry.

### Clause 5

The hardware-based video encoder of any of clauses 1-4, wherein the statistics of the video data comprises histogram statistics.

### Clause 6

The hardware-based video encoder of any of clauses 1-5, wherein the statistics of the video data comprises a count of occurrences of each value between 0 and 2^{BD}-1, wherein BD represents a bit depth of the video data.

### Clause 7

The hardware-based video encoder of any of clauses 1-6, further comprising processing circuitry configured to perform bit-rate optimization when encoding the video data based on the stored statistics.

### Clause 8

The hardware-based video encoder of any of clauses 1-7, further comprising processing circuitry configured to perform frame-rate control based on the stored statistics when encoding the video data.

### Clause 9

The hardware-based video encoder of any of clauses 1-8, wherein the video data has a bit-depth of BD, and the plurality of counting blocks includes 2^{BD} counting blocks.

### Clause 10

The hardware-based video encoder of any of clauses 1-9, wherein the set of input pixel values comprises residual values.

### Clause 11

The hardware-based video encoder of any of clauses 1-10, wherein the set of input values comprise full range pixel values.

### Clause 12

The hardware-based video encoder of any of clauses 1-11, wherein statistics computing circuitry comprising a plurality of counting blocks, wherein each counting block of the plurality of counting blocks comprises comparator circuitry configured to compare a value of each input pixel of a set of input pixel values to a set value; and accumulator circuitry configured to update the statistics based on a number of pixels of the set of input pixel values that are determined by the comparator circuitry to be equal to the set value.

### Clause 13

An autonomous driving system comprising the hardware-based video encoder of any of clauses 1-12.

### Clause 14

A method of encoding video data, the method comprising: storing, in a memory, statistics of video data; comparing, by comparator circuitry, a value of each input pixel of a set of input pixel values to a set value; and updating, by accumulator circuitry, the statistics based on a number of the input pixels of the set of input pixel values that are determined by the comparator circuitry to be equal to the set value; controlling a video encoding process based on the updated statistics.

### Clause 15

The method of clause 14, further comprising: comparing, by the comparator circuitry, the value of each input pixel of the set of input pixel values to a plurality of set values ranging from 0 to 2^{BD}-1, wherein each set value is different and BD represents a bit depth of the video data.

### Clause 16

The method of clause 14 or 15, wherein the memory comprises a flop array.

### Clause 17

The method of any of clauses 14-16, wherein the statistics of the video data comprises one or both of histogram statistics or a count of occurrences of each value between 0 and 2^{BD}-1, wherein BD represents a bit depth of the video data.

### Clause 18

The method of any of clauses 14-17, further comprising: performing one or both of bit-rate optimization or frame-rate control based on the stored statistics when encoding the video data.

### Clause 19

The method of any of clauses 14-18, wherein the set of input pixel values comprises one or both of residual values or full range pixel values.

### Clause 20

The method of any of clauses 14-19, wherein the method is performed by an autonomous driving system.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A hardware-based video encoder comprising:
a memory configured to store statistics of video data;
statistics computing circuitry comprising a plurality of counting blocks, wherein each counting block of the plurality of counting blocks comprises comparator circuitry configured to compare a value of each input pixel of a set of input pixel values to a set value;
accumulator circuitry configured to update the statistics based on a number of the input pixels of the set of input pixel values that are determined by the comparator circuitry to be equal to the set value;
control a video encoding process based on the updated statistics.

2. The hardware-based video encoder of claim 1, wherein the comparator circuitry of each counting block of the plurality of counting blocks is configured to compare the value of each input pixel of the set of input pixels to a different set value.

3. The hardware-based video encoder of claim 1, wherein the memory comprises a flop array.

4. The hardware-based video encoder of claim 1, wherein each counting block of the plurality of counting blocks further comprises summing logic configured to sum outputs of the comparator circuitry.

5. The hardware-based video encoder of claim 1, wherein the statistics of the video data comprises histogram statistics.

6. The hardware-based video encoder of claim 1, wherein the statistics of the video data comprises a count of occurrences of each value between 0 and 2^{BD}-1, wherein BD represents a bit depth of the video data.

7. The hardware-based video encoder of claim 1, further comprising processing circuitry configured to perform bit-rate optimization when encoding the video data based on the stored statistics.

8. The hardware-based video encoder of claim 1, further comprising processing circuitry configured to perform frame-rate control based on the stored statistics when encoding the video data.

9. The hardware-based video encoder of claim 1, wherein the video data has a bit-depth of BD, and the plurality of counting blocks includes 2^{BD} counting blocks.

10. The hardware-based video encoder of claim 1, wherein the set of input pixel values comprises residual values.

11. The hardware-based video encoder of claim 1, wherein the set of input values comprise full range pixel values.

12. The hardware-based video encoder of claim 1, wherein statistics computing circuitry comprising a plurality of counting blocks, wherein each counting block of the plurality of counting blocks comprises comparator circuitry configured to compare a value of each input pixel of a set of input pixel values to a set value; and
accumulator circuitry configured to update the statistics based on a number of pixels of the set of input pixel values that are determined by the comparator circuitry to be equal to the set value.

13. An autonomous driving system comprising the hardware-based video encoder of claim 1.

14. A method of encoding video data, the method comprising:
storing, in a memory, statistics of video data;
comparing, by comparator circuitry, a value of each input pixel of a set of input pixel values to a set value;
updating, by accumulator circuitry, the statistics based on a number of the input pixels of the set of input pixel values that are determined by the comparator circuitry to be equal to the set value;
controlling a video encoding process based on the updated statistics.

15. The method of claim 14, further comprising:
comparing, by the comparator circuitry, the value of each input pixel of the set of input pixel values to a plurality of set values ranging from 0 to 2^{BD}-1, wherein each set value is different and BD represents a bit depth of the video data.

16. The method of claim 14, wherein the memory comprises a flop array.

17. The method of claim 14, wherein the statistics of the video data comprises one or both of histogram statistics or a count of occurrences of each value between 0 and 2^{BD}-1, wherein BD represents a bit depth of the video data.

18. The method of claim 14, further comprising:
performing one or both of bit-rate optimization or frame-rate control based on the stored statistics when encoding the video data.

19. The method of claim 14, wherein the set of input pixel values comprises one or both of residual values or full range pixel values.

20. The method of claim 14, wherein the method is performed by an autonomous driving system.
